(19) United States
(12) Patent Application Publication
(10) Pub. No.: US 2025/0362475 A1
(43) Pub. Date: Nov. 27, 2025

(54) IMAGING LENS DRIVING MODULE, CAMERA MODULE AND ELECTRONIC DEVICE

(71) Applicant: LARGAN DIGITAL CO.,LTD., Taichung City (TW)

(72) Inventors: Yu-Tzu CHANG, Taichung City (TW); Shen-Wu HSIAO, Taichung City (TW)

(73) Assignee: LARGAN DIGITAL CO.,LTD., Taichung City (TW)

(21) Appl. No.: 18/905,044

(22) Filed: Oct. 2, 2024

(30) Foreign Application Priority Data
May 21, 2024 (TW) 113118802

(51) Int. Cl. G02B 7/09; G03B 13/36

(52) U.S. Cl. CPC G02B 7/09; G03B 13/36

(57) ABSTRACT

An imaging lens driving module includes a lens unit, a base, a cover, an autofocus driving assembly and a flexible component. The lens unit is within the internal space defined by the base and cover, and includes first and third tracks parallel to an optical axis. The base includes second and fourth tracks parallel to the optical axis. The first and second tracks accommodate a first ball. The third and fourth tracks accommodate a second ball. The total number of the first and second balls is three. The autofocus driving assembly is to drive the lens unit. The flexible component is between the lens unit and the base and/or the cover to reduce an impact. One surface of each of the first and third tracks and two surfaces of each of the second and fourth tracks each have only one contact point with either the first or second ball.

### RELATED APPLICATIONS

This application claims priority to Taiwan Application 113118802, filed on May 21, 2024, which is incorporated by reference herein in its entirety.

### BACKGROUND

### Technical Field

The present disclosure relates to an imaging lens driving module, a camera module and an electronic device, more particularly to an imaging lens driving module and a camera module applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an optical system nowadays. Furthermore, due to the rapid changes in technology, electronic devices equipped with optical systems are trending towards multi-functionality for various applications, and therefore the functionality requirements for the optical systems have been increasing.

However, in recent years, conventional optical systems have struggled to meet the high optical quality demands of diversified electronic products. In particular, the movement stability of the conventional optical systems during the focusing process may not satisfy the increasingly stringent market requirements for optical quality. Therefore, improving the mechanisms used in mobile optical systems to meet the high specifications of electronic devices nowadays has become a crucial issue in the relevant fields.

### SUMMARY

According to one aspect of the present disclosure, an imaging lens driving module includes a lens unit, a base, a cover, an autofocus driving assembly, and at least one flexible component. The lens unit has an optical axis and includes a first track and a third track extending in a direction parallel to the optical axis, wherein the first track includes a second surface, and the third track includes a third surface. The lens unit is disposed relative to the base. The base includes a second track and a fourth track extending in a direction parallel to the optical axis, wherein the second track includes a fifth surface and a sixth surface, the sixth surface and the fifth surface are connected and form an angle therebetween, the fourth track includes a seventh surface and an eighth surface, and the eighth surface and the seventh surface are connected and form an angle therebetween. The cover is coupled to the base and forms an internal space with the base, and the internal space is configured to accommodate the lens unit. The first track and the second track are correspondingly arranged to accommodate at least one first ball, and the third track and the fourth track are correspondingly arranged to accommodate at least one second ball, providing the lens unit with a degree of freedom for movement in a direction parallel to the optical axis. The total number of the at least one first ball and the at least one second ball is at least three. The autofocus driving assembly is configured to drive the lens unit to move in a direction parallel to the optical axis relative to the base. The autofocus driving assembly includes at least one magnet and at least one coil, the coil is correspondingly disposed facing the magnet, and one of the magnet and the coil is disposed on the lens unit. The flexible component is disposed between the lens unit and the base and/or between the lens unit and the cover, and the flexible component is deformable to reduce the impact caused by the lens unit bumping into adjacent components when the lens unit moves in a direction parallel to the optical axis. Preferably, the movement path of the center of the first ball along a direction parallel to the first track is defined as a first ball axis, the movement path of the center of the second ball along a direction parallel to the third track is defined as a second ball axis, and a first connection line is defined as a line connected between the first ball axis and the second ball axis in a direction perpendicular to the optical axis. Preferably, the sixth surface is located closer to the center point of the first connection line than the fifth surface, and the seventh surface is located closer to the center point of the first connection line than the eighth surface. The second surface, the fifth surface, and the sixth surface each have only one contact point with the first ball, and the third surface, the seventh surface, and the eighth surface each have only one contact point with the second ball. When an angle between the sixth surface and the seventh surface is θ₆₇, and an angle between the fifth surface and the eighth surface is θ₅₈, the following condition is satisfied: |θ₆₇−π|≤|θ₅₈−π|. Preferably, the sixth surface and the seventh surface are parallel to each other.

According to another aspect of the present disclosure, an imaging lens driving module includes a lens unit, a base, a cover, an autofocus driving assembly, and at least one flexible component. The lens unit has an optical axis and includes a first track and a third track extending in a direction parallel to the optical axis, wherein the first track includes a second surface, and the third track includes a third surface. The lens unit is disposed relative to the base. The base includes a second track and a fourth track extending in a direction parallel to the optical axis, wherein the second track includes a fifth surface and a sixth surface, the sixth surface and the fifth surface are connected and form an angle therebetween, the fourth track includes a seventh surface and an eighth surface, and the eighth surface and the seventh surface are connected and form an angle therebetween. The cover is coupled to the base and forms an internal space with the base, and the internal space is configured to accommodate the lens unit. The first track and the second track are correspondingly arranged to accommodate at least one first ball, and the third track and the fourth track are correspondingly arranged to accommodate at least one second ball, providing the lens unit with a degree of freedom for movement in a direction parallel to the optical axis. The total number of the at least one first ball and the at least one second ball is at least three. The autofocus driving assembly is configured to drive the lens unit to move in a direction parallel to the optical axis relative to the base. The autofocus driving assembly includes at least one magnet and at least one coil, the coil is correspondingly disposed facing the magnet, and one of the magnet and the coil is disposed on the lens unit. The flexible component is disposed between the lens unit and the base and/or between the lens unit and the cover, and the flexible component is deformable to reduce the impact caused by the lens unit bumping into adjacent components when the lens unit moves in a direction parallel to the optical axis. The second surface, the fifth surface, and the sixth surface each have only one contact point with the first ball, and the third surface, the seventh surface, and the eighth surface each have only one contact point with the second ball. When an angle between the sixth surface and the seventh surface is θ₆₇, and an angle between the fifth surface and the eighth surface is θ₅₈, the following condition is satisfied: |θ₆₇−π|≤|θ₅₈−π|.

According to another aspect of the present disclosure, a camera module includes one of the aforementioned imaging lens driving modules and an image sensor disposed on an image surface of the imaging lens driving module.

According to another aspect of the present disclosure, an electronic device includes the aforementioned camera module.

### BRIEF DESCRIPTION OF THE DRAWINGS

The disclosure can be better understood by reading the following detailed description of the embodiments, with reference made to the accompanying drawings as follows:

FIG. 1 is a top view of a camera module according to the 1st embodiment of the present disclosure;

FIG. 2 is a side view of the camera module in FIG. 1;

FIG. 3 is an exploded view of the camera module in FIG. 1;

FIG. 4 is another exploded view of the camera module in FIG. 1;

FIG. 5 is a cross-sectional view of the camera module taken along line 5-5 in FIG. 1;

FIG. 6 is a cross-sectional view of the camera module taken along line 6-6 in FIG. 2;

FIG. 7 is a top view of the camera module in FIG. 1 after rotation with a cover omitted;

FIG. 8 is an enlarged view of region EL1 in FIG. 7;

FIG. 9 is a schematic view of the positional relationship between tracks and balls in the camera module of FIG. 7;

FIG. 10 is a top view of a camera module according to the 2nd embodiment of the present disclosure;

FIG. 11 is a side view of the camera module in FIG. 10;

FIG. 12 is an exploded view of the camera module in FIG. 10;

FIG. 13 is another exploded view of the camera module in FIG. 10;

FIG. 14 is still another exploded view of camera module in FIG. 10;

FIG. 15 is a cross-sectional view of the camera module taken along line 15-15 in FIG. 10;

FIG. 16 is a cross-sectional view of the camera module taken along line 16-16 in FIG. 11;

FIG. 17 is a top view of the camera module in FIG. 10 after rotation with a cover omitted;

FIG. 18 is a schematic view of the positional relationship between tracks and balls in the camera module of FIG. 17;

FIG. 19 is a top view of a flexible circuit board, an autofocus driving assembly and a base in the camera module in FIG. 10;

FIG. 20 is a top view of a flexible circuit board, an autofocus driving assembly and a base in a camera module according to a first exemplary configuration of the present disclosure;

FIG. 21 is a top view of a flexible circuit board, an autofocus driving assembly and a base in a camera module according to a second exemplary configuration of the present disclosure;

FIG. 22 is a perspective view of a flexible circuit board, an autofocus driving assembly and a base in a camera module according to a third exemplary configuration of the present disclosure;

FIG. 23 is a top view of the flexible circuit board, the autofocus driving assembly and the base in the camera module of FIG. 22;

FIG. 24 is a perspective view of an electronic device according to the 3rd embodiment of the present disclosure;

FIG. 25 is another perspective view of the electronic device in FIG. 24;

FIG. 26 is an illustration of an image captured by an ultra-wide-angle camera module;

FIG. 27 is an illustration of an image captured by a high pixel camera module;

FIG. 28 is an illustration of an image captured by a telephoto camera module;

FIG. 29 is a perspective view of an electronic device according to the 4th embodiment of the present disclosure;

FIG. 30 is a perspective view of an electronic device according to the 5th embodiment of the present disclosure;

FIG. 31 is a side view of the electronic device in FIG. 30; and

FIG. 32 is a top view of the electronic device in FIG. 30.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an imaging lens driving module. The imaging lens driving module includes a lens unit, a base, a cover, an autofocus driving assembly, and at least one flexible component.

The lens unit is disposed relative to the base. The cover is coupled to the base and forms an internal space with the base, and the internal space is configured to accommodate the lens unit.

The lens unit has an optical axis and includes a first track and a third track extending in a direction parallel to the optical axis. The first track includes a second surface, and the third track includes a third surface. The base includes a second track and a fourth track extending in a direction parallel to the optical axis. The second track includes a fifth surface and a sixth surface, and the sixth surface and the fifth surface are connected and form an angle therebetween. The fourth track includes a seventh surface and an eighth surface, and the eighth surface and the seventh surface are connected and form an angle therebetween.

The first track and the second track are correspondingly arranged to accommodate at least one first ball, and the third track and the fourth track are correspondingly arranged to accommodate at least one second ball, which are configured to provide the lens unit with a degree of freedom for movement in a direction parallel to the optical axis. In other words, the first track and the second track are correspondingly arranged to each other, and the third track and the fourth track are correspondingly arranged to each other, thereby forming two spaces respectively configured to accommodate the at least one first ball and the at least one second ball. Moreover, the total number of the first and second balls is at least three. For example, in one configuration of the present disclosure, when at least two first balls and at least two second balls are respectively provided, the stability of the lens unit during movement can be enhanced. However, in another configuration of the present disclosure, when the overall space of the imaging lens driving module is limited, the total number of one of the first ball and the second ball can be one, and the total number of the other of the first ball and the second ball can be at least two, but the present disclosure is not limited thereto.

The autofocus driving assembly is configured to drive the lens unit to move in a direction parallel to the optical axis relative to the base. Specifically, the autofocus driving assembly includes at least one magnet and at least one coil. The coil is correspondingly disposed facing the magnet, and one of the magnet and the coil is disposed on the lens unit. For example, in one configuration of the present disclosure, one of the magnet and the coil is disposed on the lens unit, and the other of the magnet and the coil is disposed on the base. Additionally, the present disclosure is not limited to the number of magnets and coils. For instance, in one configuration of the present disclosure, the number of magnet is one and the number of coil is one, and the one coil is correspondingly disposed facing the one magnet. In another configuration of the present disclosure, the number of magnets and the number of coils are multiple, and the coils are correspondingly disposed facing the magnets.

The flexible component is disposed between the lens unit and the base and/or between the lens unit and the cover, and the flexible component is deformable to reduce the impact caused by the lens unit bumping into adjacent components when the lens unit moves in a direction parallel to the optical axis. Moreover, the flexible component can be, for example, made of rubber material or silicone material, but the present disclosure is not limited thereto. The flexible component disposed between the lens unit and the base and/or between the lens unit and the cover refers to the flexible component being disposed between at least one of the lens unit and the base, and the lens unit and the cover.

The second surface of the first track, the fifth surface and the sixth surface of the second track each have only one contact point with the first ball, and the third surface of the third track, the seventh surface and the eighth surface of the fourth track each have only one contact point with the second ball.

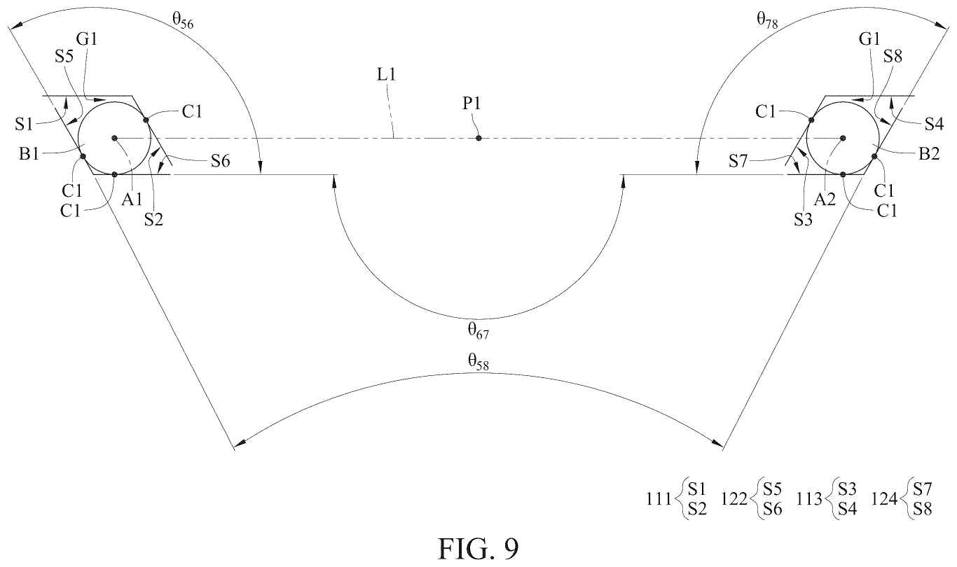

When an angle between the sixth surface and the seventh surface is θ₆₇, and an angle between the fifth surface and the eighth surface is θ₅₈, the following condition is satisfied: |θ₆₇−π|≤|θ₅₈−π|. Please refer to FIG. 9, which shows a schematic view of θ₅₈ and θ₆₇ according to the 1st embodiment of the present disclosure.

According to the present disclosure, by providing the flexible component between the lens unit and the base and/or between the lens unit and the cover, the impact caused by the lens unit bumping into adjacent components can be reduced, ensuring the stability of the lens unit and extending its lifespan. Additionally, the configuration of the tracks and the balls ensures the stability of the lens unit during autofocus movement, thereby improving imaging quality.

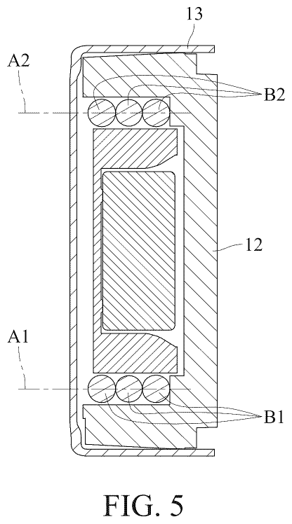

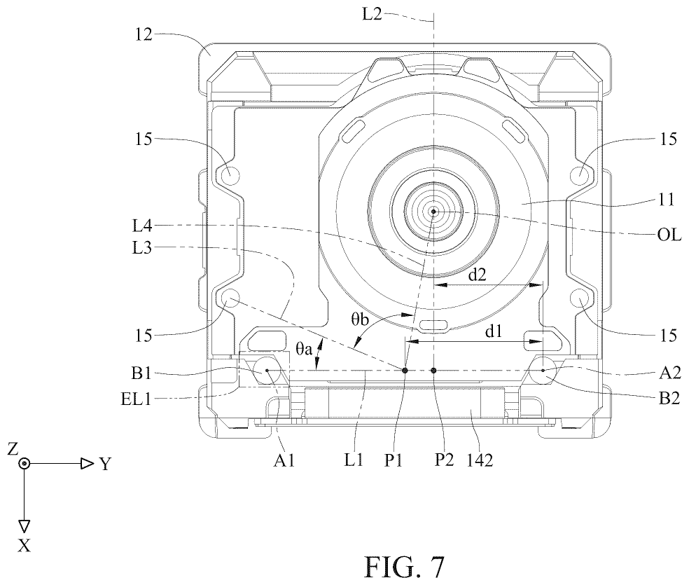

The movement path of the center of the first ball along a direction parallel to the first track is defined as a first ball axis, the movement path of the center of the second ball along a direction parallel to the third track is defined as a second ball axis, and a first connection line is defined as a line connected between the first ball axis and the second ball axis in a direction perpendicular to the optical axis. Moreover, the first ball axis and the second ball axis are two different ball axes, both substantially parallel to the optical axis. The term “substantially parallel to the optical axis” refers to that the inclination angle of each of these two ball axes relative to the optical axis does not exceed 3 degrees. Please refer to FIG. 5 and FIG. 7, which respectively illustrate schematic views of the first ball axis A1, the second ball axis A2, and the first connection line L1 according to the 1st embodiment of the present disclosure.

The sixth surface can be located closer to a center point of the first connection line than the fifth surface, and the seventh surface can be located closer to the center point of the first connection line than the eighth surface. Additionally, the sixth surface and the seventh surface can be parallel to each other. The sixth surface and the seventh surface being parallel to each other refers to that the sixth surface and the seventh surface are substantially parallel, with the inclination angle between the two surfaces not exceeding 3 degrees. Please refer to FIG. 7 and FIG. 9, which respectively illustrate schematic views of the positional relationship between the center point P1 of the first connection line L1 and the fifth surface S5, the sixth surface S6, the seventh surface S7, and the eighth surface S8 according to the 1st embodiment of the present disclosure.

In one configuration of the present disclosure, the flexible component can be coupled to the base, and the flexible component can face the lens unit. Therefore, by the arrangement of the flexible component as described above, the impact caused by the lens unit bumping into adjacent components can be reduced, ensuring the stability of the lens unit and extending its lifespan. Moreover, the flexible component coupled to the base can serve as a buffer between the base and the lens unit.

In one configuration of the present disclosure, the flexible component can be coupled to the lens unit, and the flexible component can face the cover. Therefore, by the arrangement the flexible component as described above, the impact caused by the lens unit bumping into adjacent components can be reduced, ensuring the stability of the lens unit and extending its lifespan. Moreover, the flexible component coupled to the lens unit can serve as a buffer between the lens unit and the cover.

The flexible component can include at least two flexible components, and the at least two flexible components can be respectively disposed between the lens unit and the base, and between the lens unit and the cover. Therefore, by the arrangement of the flexible components as described above, the impact caused by the lens unit bumping into adjacent components can be reduced, ensuring the stability of the lens unit and extending its lifespan. Moreover, the flexible components disposed between the lens unit and the base, and between the lens unit and the cover, can reduce the impact caused by the lens unit bumping with the base and the cover when the lens unit moves in the direction of the optical axis.

The total number of flexible components can be eight. Therefore, a suitable arrangement of the number of flexible components can reduce the impact caused by the lens unit bumping into adjacent components, ensuring the stability of the lens unit and extending its lifespan.

In one configuration of the present disclosure, the magnet can be disposed on the lens unit, the coil can be disposed on the base, and the coil is correspondingly disposed facing the magnet. Therefore, the magnet and the coil can be disposed in the optimal driving positions, which is favorable for increasing the design flexibility of the autofocus driving assembly. With this configuration, the magnet can move in a direction parallel to the optical axis along with the lens unit, while the coil remains fixed on the base.

In one configuration of the present disclosure, the coil can be disposed on the lens unit, the magnet can be disposed on the base, and the magnet is correspondingly disposed facing the coil. Therefore, the coil and the magnet can be disposed in optimal driving positions, which is favorable for increasing the design flexibility of the autofocus driving assembly. With this configuration, the coil can move in a direction parallel to the optical axis along with the lens unit, while the magnet remains fixed on the base.

According to the present disclosure, the imaging lens driving module can further include a flexible circuit board, and the flexible circuit board can be coupled to the lens unit. Therefore, by utilizing the bendable characteristics of the flexible circuit board, the flexible circuit board has sufficient flexibility to follow the autofocus movement of the lens unit, thereby meeting the driving requirements in all directions. Moreover, the flexible circuit board can be designed with suitable wiring to enable movement along with the lens unit in the direction parallel to the optical axis.

In one configuration of the present disclosure, the coil can be disposed on the flexible circuit board, and the flexible circuit board can include a meandering circuit with sections overlapping in a direction perpendicular to the optical axis. Therefore, the design flexibility of the flexible circuit board can be increased, making the flexible circuit board sufficient to meet the driving requirements in all directions. Moreover, the flexible circuit board can move with the lens unit during the autofocus process, thus enhancing its flexibility through the meandering circuit, but the present disclosure is not limited thereto.

In one configuration of the present disclosure, the coil can be disposed on the flexible circuit board, and the flexible circuit board can include a folding circuit with sections overlapping in a direction parallel to the optical axis. Therefore, the design flexibility of the flexible circuit board can be increased, making the flexible circuit board sufficient to meet the driving requirements in all directions. Moreover, the flexible circuit board can move with the lens unit during the autofocus process, thus enhancing its flexibility through the folding circuit, but the present disclosure is not limited thereto.

The at least one first ball can include at least two first balls, and the at least one second ball can include at least two second balls. In other words, the number of first balls can be at least two, and the number of second balls can be at least two. Therefore, a suitable arrangement of the number of balls can enhance the stability of the lens unit during movement.

According to the present disclosure, a second connection line is defined as a line orthogonal to and intersecting both the optical axis and the first connection line, and connected between the optical axis and the first connection line. An intersection of the first connection line and the second connection line is an eccentric point. When a distance between the center point of the first connection line and the second ball axis is d1, and a distance between the eccentric point and the second ball axis is d2, the following condition can be satisfied: 1.1≤d1/d2<4.9. Therefore, through the eccentric design, the imaging lens driving module can be arranged at the corner of a mobile phone screen, thereby facilitating to enhance the utilization of the interior space of the mobile phone. Moreover, the eccentric point and the center point are located at two different positions, with the eccentric point being closer to one of the ball axes. Please refer to FIG. 7, which shows a schematic view of the first connection line L1 and the center point P1 thereof, the second connection line L2, the eccentric point P2, and d1 and d2 according to the 1st embodiment of the present disclosure.

According to the present disclosure, a third connection line is defined as a line connected between the center of the flexible component and the center point of the first connection line, and a fourth connection line is defined as a line orthogonal to and intersecting the optical axis, and connected between the optical axis and the center point of the first connection line. When an angle between the third connection line and the first connection line is θa, and an angle between the third connection line and the fourth connection line is θb, the following condition can be satisfied: θa+θb≠90 degrees. Therefore, through the eccentric design, the imaging lens driving module can be arranged at the corner of a mobile phone screen, thereby facilitating to enhance the utilization of the inner space of the mobile phone. Further explanation, θa can also refer to an angle between the third connection line and a section of the first connection line located between the center point and the ball axis farthest from the eccentric point in a direction parallel to the first connection line. Please refer to FIG. 7, which shows a schematic view of the first connection line L1 and the center point P1 thereof, the third connection line L3, the fourth connection line L4, and θa and θb according to the 1st embodiment of the present disclosure.

When an angle between the fifth surface and the sixth surface of the second track is θ₅₆, the following condition can be satisfied: π/2≤θ₅₆<π. Therefore, the design flexibility of the track can be increased, making the track applicable for various driving means. Moreover, the following condition can also be satisfied: 98 degrees≤θ₅₆<π. Moreover, the corner formed between the fifth surface and the sixth surface can be either a sharp corner or a rounded corner, but the present disclosure is not limited thereto. Please refer to FIG. 9, which shows a schematic view of θ₅₆ according to the 1st embodiment of the present disclosure.

When an angle between the seventh surface and the eighth surface of the fourth track is θ₇₈, the following condition can be satisfied: π/2≤θ₇₈<π. Therefore, the design flexibility of the track can be increased, making the track applicable for various driving means. Moreover, the following condition can also be satisfied: 98 degrees≤θ₇₈<π. Moreover, the angle between the seventh surface and the eighth surface can be formed as either a sharp angle or a rounded angle, but the present disclosure is not limited thereto. Please refer to FIG. 9, which shows a schematic view of θ₇₈ according to the 1st embodiment of the present disclosure.

The first track can further include a first surface, and the first surface and the second surface can be connected and form an angle therebetween. Additionally, the third track can further include a fourth surface, and the fourth surface and the third surface can be connected and form an angle therebetween. There can be a gap between the first surface and the first ball and/or between the fourth surface and the second ball; in other words, there can be a gap between at least one set of the first surface and the first ball, and the fourth surface and the second ball. The first surface and the sixth surface can be parallel to each other, and the fourth surface and the seventh surface can be parallel to each other. Therefore, the gap(s) can be utilized to adjust manufacturing precision, thereby enhancing the feasibility of mass production. In one configuration of the present disclosure, there can be a gap between the first surface and the first ball, and there can also be a gap between the fourth surface and the second ball, but the present disclosure is not limited thereto.

According to the present disclosure, a camera module is provided. The camera module includes an image sensor and the aforementioned imaging lens driving module, and the image sensor is disposed on an image surface of the imaging lens driving module.

According to the present disclosure, an electronic device is provided. The electronic device includes the aforementioned camera module.

According to the present disclosure, the aforementioned features and conditions can be utilized in numerous combinations so as to achieve corresponding effects.

According to the above description of the present disclosure, the following specific embodiments are provided for further explanation.

### 1st Embodiment

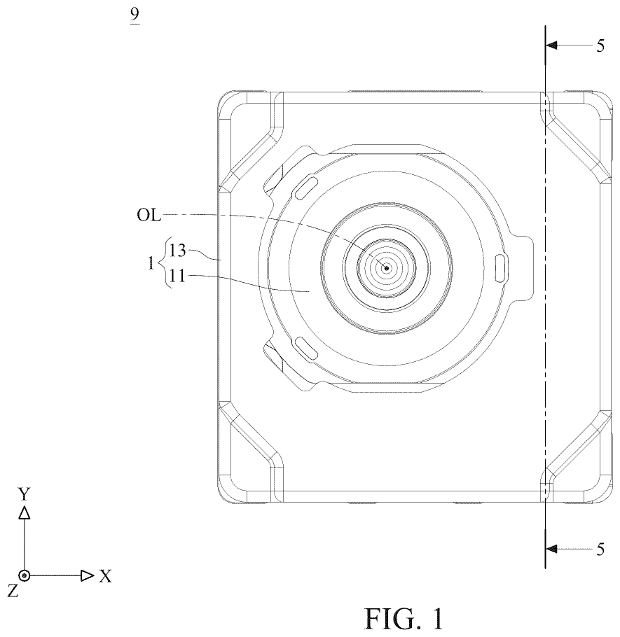

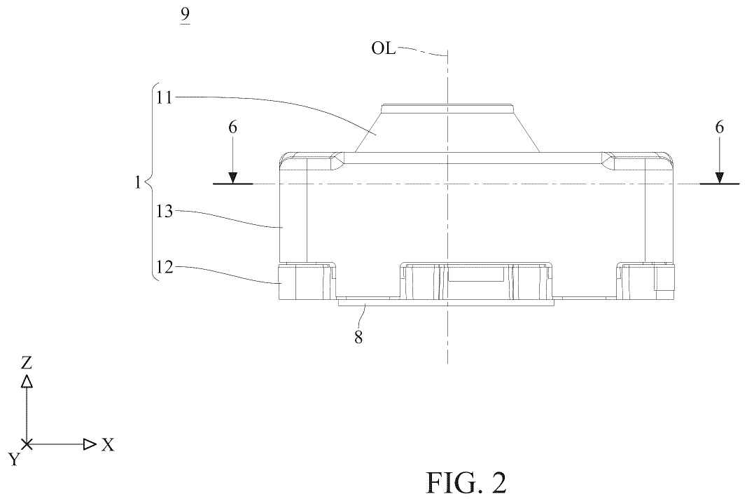

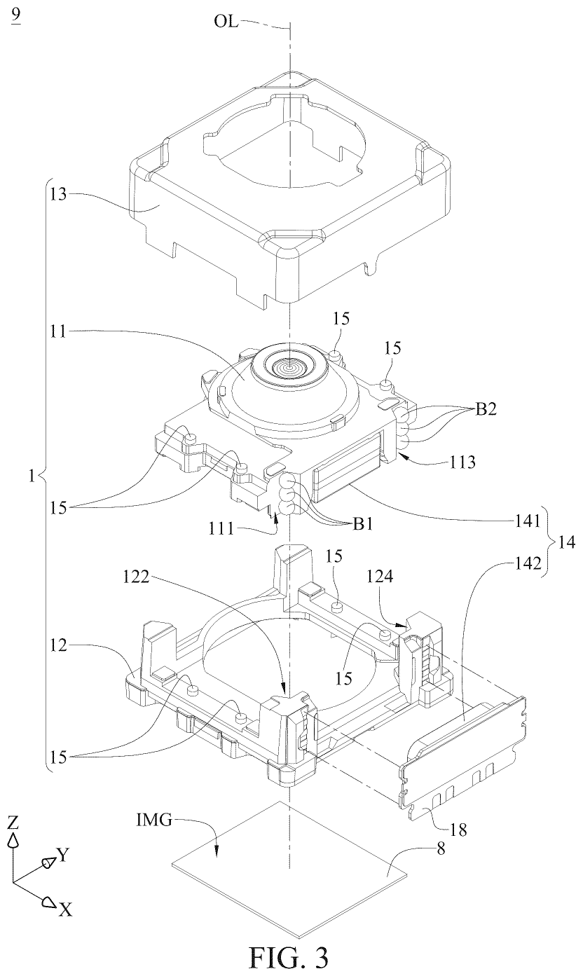

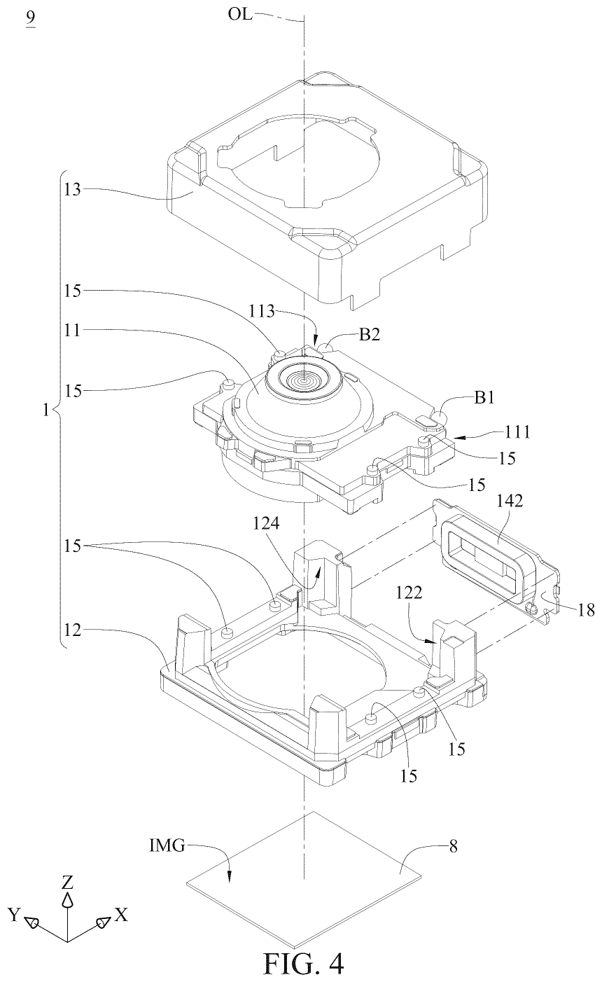

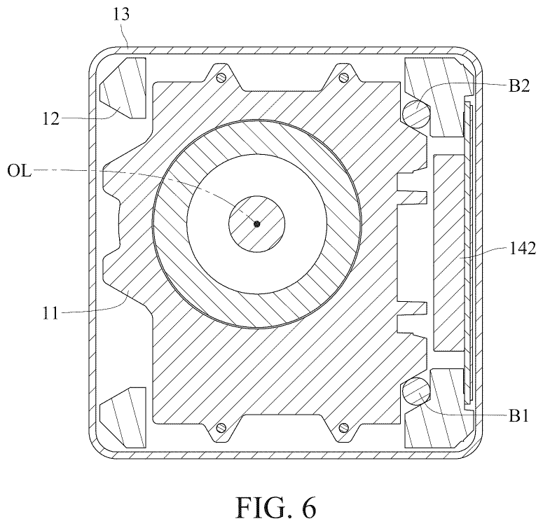

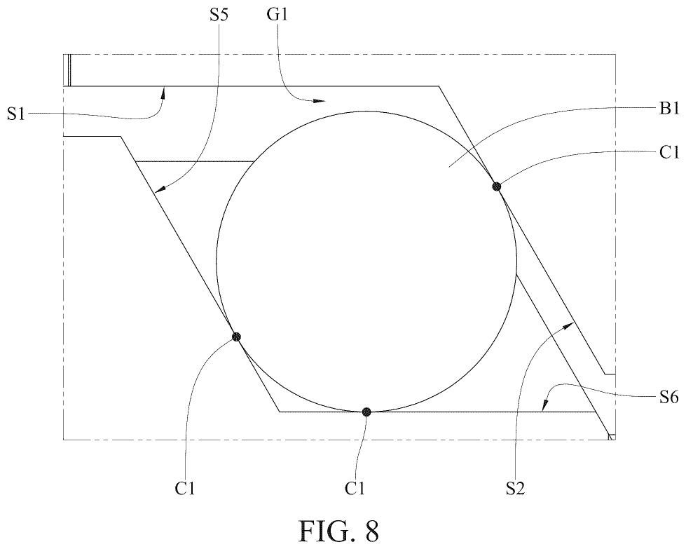

FIG. 1 is a top view of a camera module according to the 1st embodiment of the present disclosure, FIG. 2 is a side view of the camera module in FIG. 1, FIG. 3 is an exploded view of the camera module in FIG. 1, FIG. 4 is another exploded view of the camera module in FIG. 1, FIG. 5 is a cross-sectional view of the camera module taken along line 5-5 in FIG. 1, FIG. 6 is a cross-sectional view of the camera module taken along line 6-6 in FIG. 2, FIG. 7 is a top view of the camera module in FIG. 1 after rotation with a cover omitted, FIG. 8 is an enlarged view of region EL1 in FIG. 7, and FIG. 9 is a schematic view of the positional relationship between tracks and balls in the camera module of FIG. 7.

A camera module 9 is provided in this embodiment. The camera module 9 includes an imaging lens driving module 1 and an image sensor 8, and the image sensor 8 is disposed on an image surface IMG of the imaging lens driving module 1.

The imaging lens driving module 1 includes a lens unit 11, a base 12, a cover 13, an autofocus driving assembly 14 and eight flexible components 15.

The lens unit 11 is disposed relative to the base 12, and the cover 13 is coupled to the base 12 and forms an internal space (its reference numeral is omitted) with the base 12. The internal space is configured to accommodate the lens unit 11.

The lens unit 11 has an optical axis OL, and the lens unit 11 includes a first track 111 and a third track 113 extending in a direction parallel to the optical axis OL. As shown in FIG. 8 and FIG. 9, the first track 111 includes a first surface S1 and a second surface S2, and the second surface S2 and the first surface S1 are connected and form an angle therebetween. The third track 113 includes a third surface S3 and a fourth surface S4, and the fourth surface S4 and the third surface S3 are connected and form an angle therebetween.

The base 12 includes a second track 122 and a fourth track 124 extending in a direction parallel to the optical axis OL. As shown in FIG. 8 and FIG. 9, the second track 122 includes a fifth surface S5 and a sixth surface S6, and the sixth surface S6 are the fifth surface S5 are connected and form an angle therebetween. The fourth track 124 includes a seventh surface S7 and an eighth surface S8, and the eighth surface S8 and the seventh surface S7 are connected and form an angle therebetween.

The first track 111 and the second track 122 are correspondingly arranged to accommodate three first balls B1, and the third track 113 and the fourth track 124 are correspondingly arranged to accommodate three second balls B2, providing the lens unit 11 with a degree of freedom for movement in a direction parallel to the optical axis OL.

As shown in FIG. 7 to FIG. 9, there is a gap G1 between the first surface S1 and the first ball B1, and a gap G1 between the fourth surface S4 and the second ball B2. Additionally, the first surface S1 of the first track 111 is parallel to the sixth surface S6 of the second track 122, the fourth surface S4 of the third track 113 is parallel to the seventh surface S7 of the fourth track 124, and the sixth surface S6 of the second track 122 is parallel to the seventh surface S7 of the fourth track 124.

As shown in FIG. 9, each of the first balls B1 has only one contact point C1 with the second surface S2, only one contact point C1 with the fifth surface S5, and only one contact point C1 with the sixth surface S6. Similarly, each of the second balls B2 has only one contact point C1 with the third surface S3, only one contact point C1 with the seventh surface S7, and only one contact point C1 with the eighth surface S8.

When an angle between the sixth surface S6 and the seventh surface S7 is 067, and an angle between the fifth surface S5 and the eighth surface S8 is θ₅₈, the following conditions are satisfied: θ₆₇=180 degrees; θ₅₈=60 degrees; and |θ₆₇−π|<|θ₅₈−π|.

When an angle between the fifth surface S5 and the sixth surface S6 is θ₅₆, the following condition is satisfied: θ₅₆=120 degrees.

When an angle between the seventh surface S7 and the eighth surface S8 is θ₇₈, the following condition is satisfied: θ₇₈=120 degrees.

As shown in FIG. 5 and FIG. 7, the movement path of the center of the first ball B1 along a direction parallel to the first track 111 is defined as a first ball axis A1, and the movement path of the center of the second ball B2 along a direction parallel to the third track 113 is defined as a second ball axis A2. Additionally, a first connection line L1 is defined as a line connected between the first ball axis A1 and the second ball axis A2 in a direction perpendicular to the optical axis OL, and a second connection line L2 is defined as a line orthogonal to and intersecting both the optical axis OL and the first connection line L1, and connected between the optical axis OL and the first connection line L1.

According to the aforementioned definitions, the sixth surface S6 is located closer to a center point P1 of the first connection line L1 than the fifth surface S5, and the seventh surface S7 is located closer to the center point P1 of the first connection line L1 than the eighth surface S8. Additionally, an intersection point of the first connection line L1 and the second connection line L2 is defined as an eccentric point P2, and the eccentric point P2 is located closer to the second ball axis A2 (i.e., the distance between the eccentric point P2 and the first ball axis A1 is larger than the distance between the eccentric point P2 and the second ball axis A2).

Furthermore, when a distance between the center point P1 of the first connection line L1 and the second ball axis A2 is d1, and a distance between the eccentric point P2 and the second ball axis A2 is d2, the following conditions are satisfied: d1=3.01 mm; d2=2.38 mm; and d1/d2=1.26.

The autofocus driving assembly 14 is configured to drive the lens unit 11 to move in a direction parallel to the optical axis OL relative to the base 12. Specifically, the autofocus driving assembly 14 includes a magnet 141 and a coil 142, with the coil 142 correspondingly disposed facing the magnet 141. The magnet 141 is disposed on the lens unit 11, and the coil 142 is disposed on the base 12. In this embodiment, the coil 142 is disposed on the base 12, for example, via a circuit board 18 attached to the base 12.

Among the flexible components 15, four of the flexible components 15 are disposed between the lens unit 11 and the base 12, and the other four of the flexible components 15 are disposed between the lens unit 11 and the cover 13. The deformability of the flexible components 15 is configured to reduce the impact caused by the lens unit 11 bumping into adjacent components when the lens unit 11 moves in a direction parallel to the optical axis OL. In this embodiment, the flexible components 15 disposed between the lens unit 11 and the base 12 are coupled to the base 12 and face the lens unit 11, and the flexible components 15 disposed between the lens unit 11 and the cover 13 are coupled to the lens unit 11 and face the cover 13.

Furthermore, as shown in FIG. 7, a third connection line L3 is defined as a line connected between the center of the flexible component 15 and the center point P1 of the first connection line L1, and a fourth connection line L4 is defined as a line orthogonal to and intersecting the optical axis OL and connected between the optical axis OL and the center point P1 of the first connection line L1. When an angle between the third connection line L3 and the first connection line L1 is θa, and an angle between the third connection line L3 and the fourth connection line L4 is θb, the following conditions are satisfied: θa=23 degrees; θb=78 degrees; and θa+θb=101 degrees.

### 2nd Embodiment

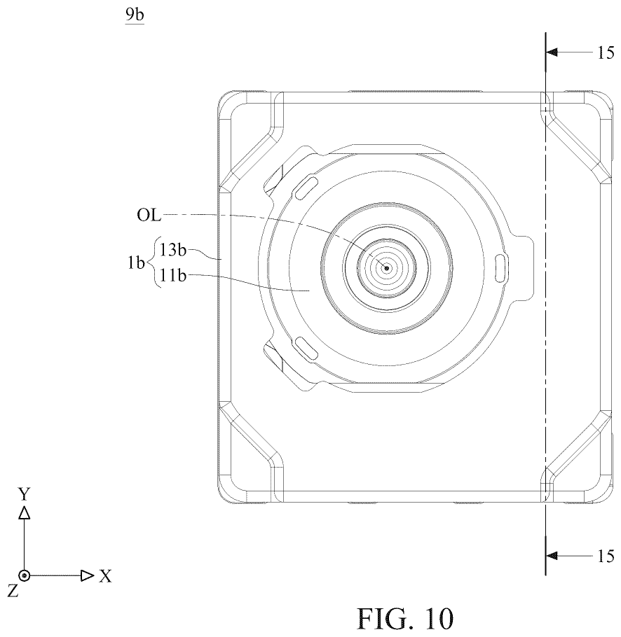

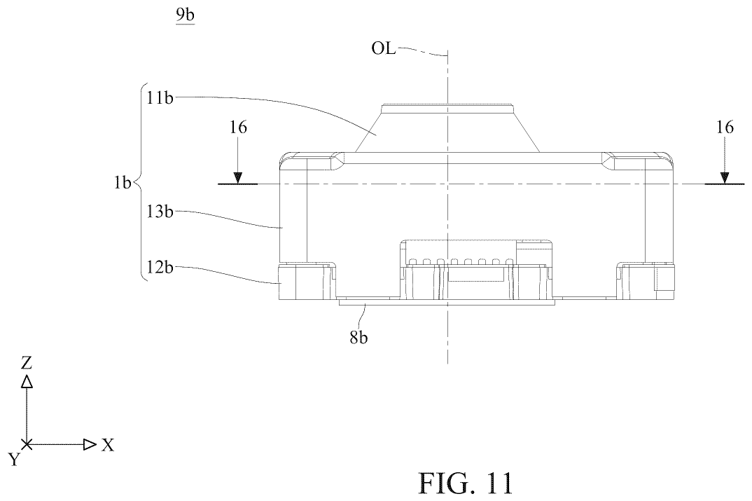

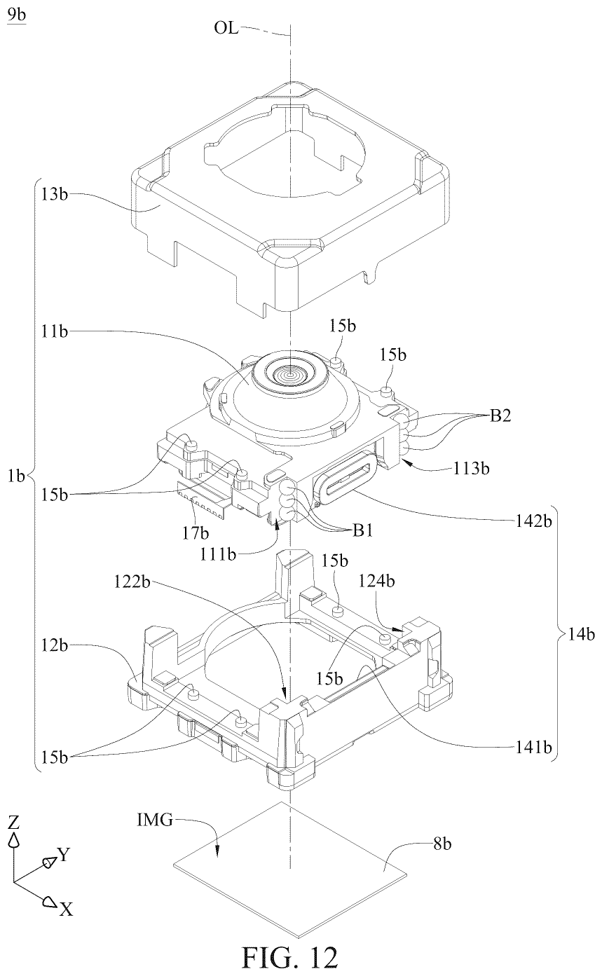

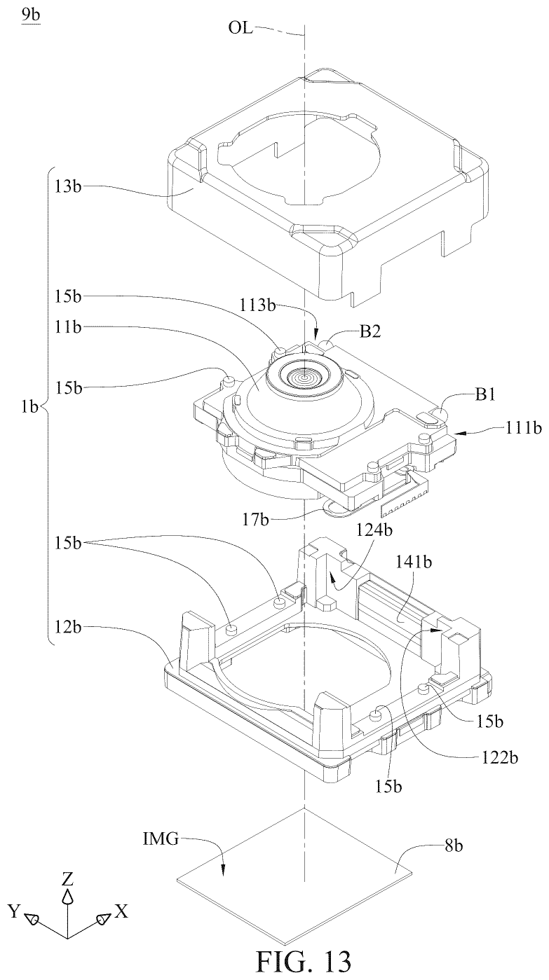

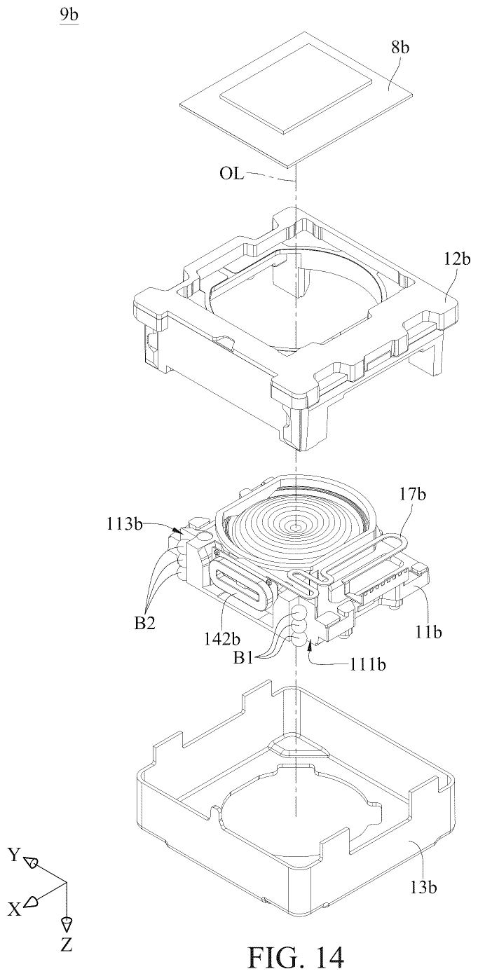

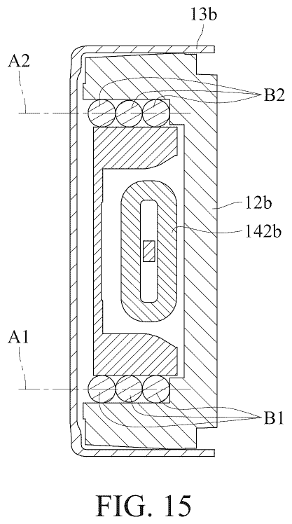

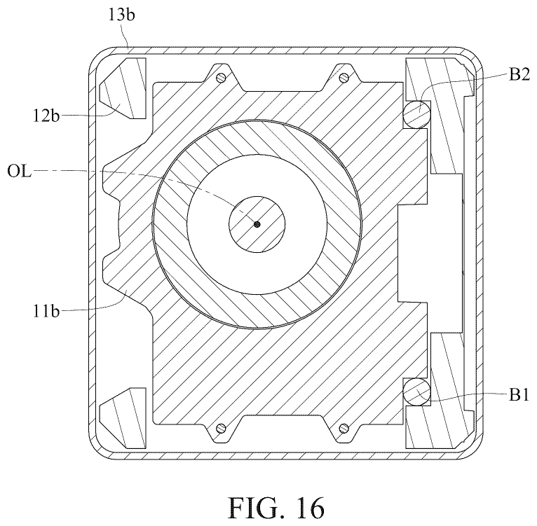

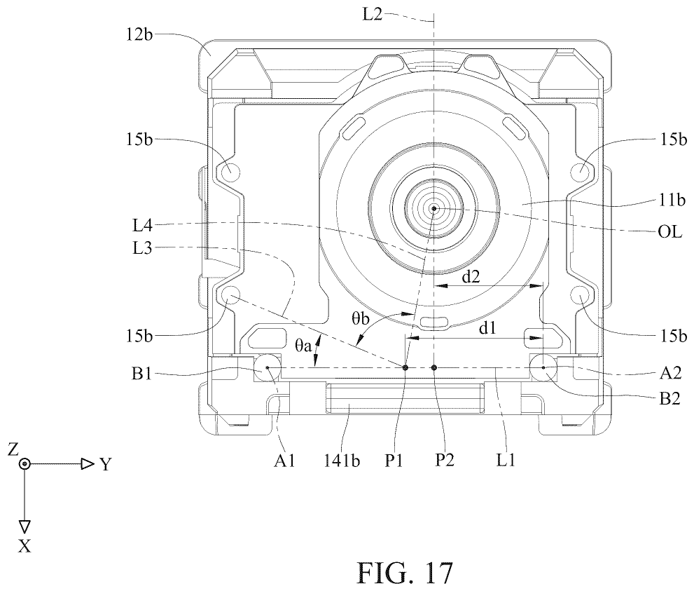

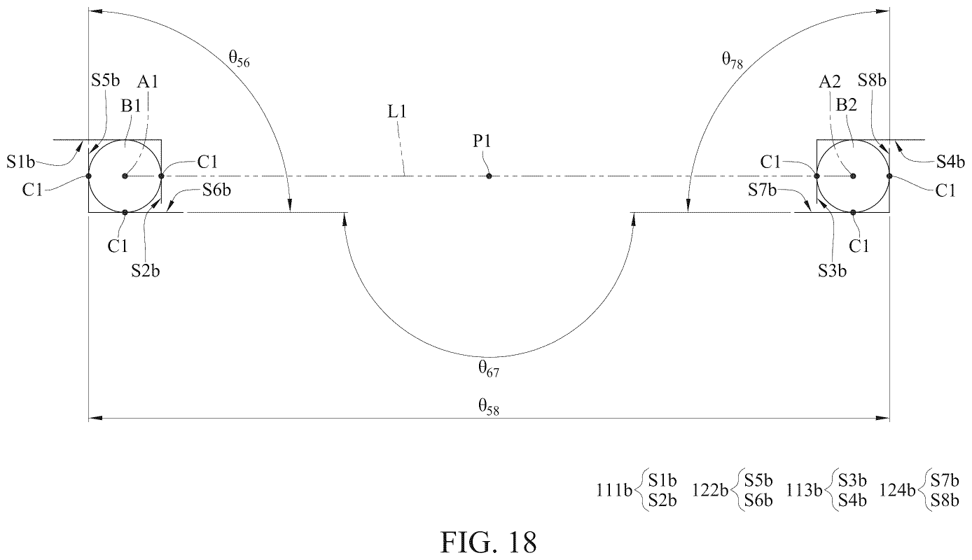

FIG. 10 is a top view of a camera module according to the 2nd embodiment of the present disclosure, FIG. 11 is a side view of the camera module in FIG. 10, FIG. 12 is an exploded view of the camera module in FIG. 10, FIG. 13 is another exploded view of the camera module in FIG. 10, FIG. 14 is still another exploded view of camera module in FIG. 10, FIG. 15 is a cross-sectional view of the camera module taken along line 15-15 in FIG. 10, FIG. 16 is a cross-sectional view of the camera module taken along line 16-16 in FIG. 11, FIG. 17 is a top view of the camera module in FIG. 10 after rotation with a cover omitted, and FIG. 18 is a schematic view of the positional relationship between tracks and balls in the camera module of FIG. 17.

A camera module 9b is provided in this embodiment. The camera module 9b includes an imaging lens driving module 1b and an image sensor 8b, and the image sensor 8b is disposed on an image surface IMG of the imaging lens driving module 1b.

The imaging lens driving module 1b includes a lens unit 11b, a base 12b, a cover 13b, an autofocus driving assembly 14b, eight flexible components 15b and a flexible circuit board 17b.

The lens unit 11b is disposed relative to the base 12b, and the cover 13b is coupled to the base 12b and forms an internal space (its reference numeral is omitted) with the base 12b. The internal space is configured to accommodate the lens unit 11b.

The lens unit 11b has an optical axis OL and includes a first track 111b and a third track 113b extending in a direction parallel to the optical axis OL. As shown in FIG. 18, the first track 111b includes a first surface S1b and a second surface S2b, and the second surface S2b and the first surface S1b are connected and form an angle therebetween. The third track 113b includes a third surface S3b and a fourth surface S4b, and the fourth surface S4b and the third surface S3b are connected and form an angle therebetween.

The base 12b includes a second track 122b and a fourth track 124b extending in a direction parallel to the optical axis OL. As shown in FIG. 18, the second track 122b includes a fifth surface S5b and a sixth surface S6b, and the sixth surface S6b and the fifth surface S5b are connected and form an angle therebetween. The fourth track 124b includes a seventh surface S7b and an eighth surface S8b, and the eighth surface S8b and the seventh surface S7b are connected and form an angle therebetween.

The first track 111b and the second track 122b are correspondingly arranged to accommodate three first balls B1, and the third track 113b and the fourth track 124b are correspondingly arranged to accommodate three second balls B2, providing the lens unit 11b with a degree of freedom for movement in a direction parallel to the optical axis OL.

As shown in FIG. 17 and FIG. 18, the first surface S1b of the first track 111b is parallel to the sixth surface S6b of the second track 122b, the fourth surface S4b of the third track 113b is parallel to the seventh surface S7b of the fourth track 124b, and the sixth surface S6b of the second track 122b is parallel to the seventh surface S7b of the fourth track 124b.

As shown in FIG. 18, each of the first balls B1 has only one contact point C1 with the second surface S2b, only one contact point C1 with the fifth surface S5b, and only one contact point C1 with the sixth surface S6b, and each of the second balls B2 has only one contact point C1 with the third surface S3b, only one contact point C1 with the seventh surface S7b, and only one contact point C1 with the eighth surface S8b.

When an angle between the sixth surface S6b and the seventh surface S7b is θ₆₇, and an angle between the fifth surface S5b and the eighth surface S8b is θ₅₈, the following conditions are satisfied: θ₆₇=180 degrees; θ₅₈=180 degrees; and |θ₆₇−π|=|θ₅₈−π|. In this embodiment, the sixth surface S6b and the seventh surface S7b are parallel to each other, so the angle θ₆₇ between the sixth surface S6b and the seventh surface S7b is 180 degrees; the fifth surface S5b and the eighth surface S8b are parallel to each other, so the angle θ₅₈ between the fifth surface S5b and the eighth surface S8b is 180 degrees.

When an angle between the fifth surface S5b and the sixth surface S6b is θ₅₆, the following condition is satisfied: θ₅₆=90 degrees.

When an angle between the seventh surface S7b and the eighth surface S8b is θ₇₈, the following condition is satisfied: θ₇₈=90 degrees.

As shown in FIG. 15 and FIG. 17, the movement path of the center of the first ball B1 along a direction parallel to the first track 111b is defined as a first ball axis A1, and the movement path of the center of the second ball B2 along a direction parallel to the third track 113b is defined as a second ball axis A2. Additionally, a first connection line L1 is defined as a line connected between the first ball axis A1 and the second ball axis A2 in a direction perpendicular to the optical axis OL, and a second connection line L2 is defined as a line orthogonal to and intersecting both the optical axis OL and the first connection line L1 and connected between the optical axis OL and the first connection line L1.

According to the aforementioned definitions, the sixth surface S6b is located closer to a center point P1 of the first connection line L1 than the fifth surface S5b, and the seventh surface S7b is located closer to the center point P1 of the first connection line L1 than the eighth surface S8b. Additionally, an intersection point of the first connection line L1 and the second connection line L2 is defined as an eccentric point P2, and the eccentric point P2 is located closer to the second ball axis A2 (i.e., the distance between the eccentric point P2 and the first ball axis A1 is larger than the distance between the eccentric point P2 and the second ball axis A2).

Additionally, when a distance between the center point P1 of the first connection line L1 and the second ball axis A2 is d1, and a distance between the eccentric point P2 and the second ball axis A2 is d2, the following conditions are satisfied: d1=3.01 mm; d2=2.38 mm; and d1/d2=1.26.

The autofocus driving assembly 14b is configured to drive the lens unit 11b to move in a direction parallel to the optical axis OL relative to the base 12b. Specifically, the autofocus driving assembly 14b includes a magnet 141b and a coil 142b, with the coil 142b correspondingly disposed facing the magnet 141b. The coil 142b is disposed on the lens unit 11b, and the magnet 141b is disposed on the base 12b.

Among the flexible components 15b, four of the flexible components 15b are disposed between the lens unit 11b and the base 12b, and the other four of the flexible components 15b are disposed between the lens unit 11b and the cover 13b. The deformability of the flexible components 15b is configured to reduce the impact caused by the lens unit 11b bumping into adjacent components when the lens unit 11b moves in a direction parallel to the optical axis OL. In this embodiment, the flexible components 15b disposed between the lens unit 11b and the base 12b are coupled to the base 12b and face the lens unit 11b, and the flexible components 15b disposed between the lens unit 11b and the cover 13b are coupled to the lens unit 11b and face the cover 13b.

Furthermore, as shown in FIG. 17, a third connection line L3 is defined as a line connected between the center of the flexible component 15b and the center point P1 of the first connection line L1, and a fourth connection line L4 is defined as a line orthogonal to and intersecting the optical axis OL and connected between the optical axis OL and the center point P1 of the first connection line L1. When an angle between the third connection line L3 and the first connection line L1 is θa, and an angle between the third connection line L3 and the fourth connection line L4 is θb, the following conditions are satisfied: θa=23 degrees; θb=78 degrees; and θa+θb=101 degrees.

The flexible circuit board 17b is coupled to the lens unit 11b, and the coil 142b is disposed on the flexible circuit board 17b. In other words, in this embodiment, the coil 142b is disposed on the lens unit 11b via the flexible circuit board 17b coupled to the lens unit 11b.

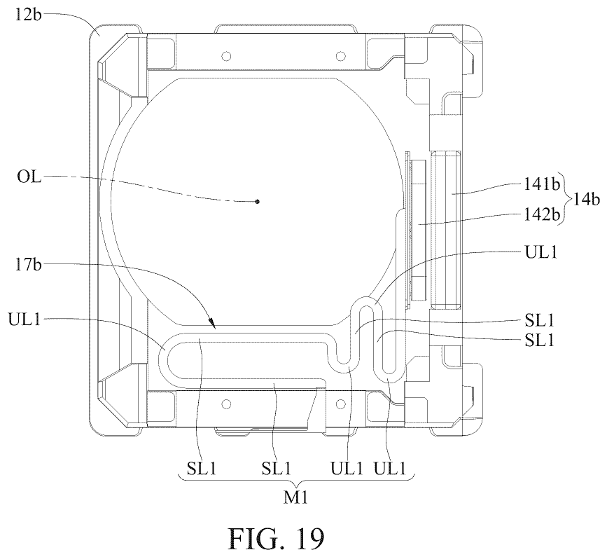

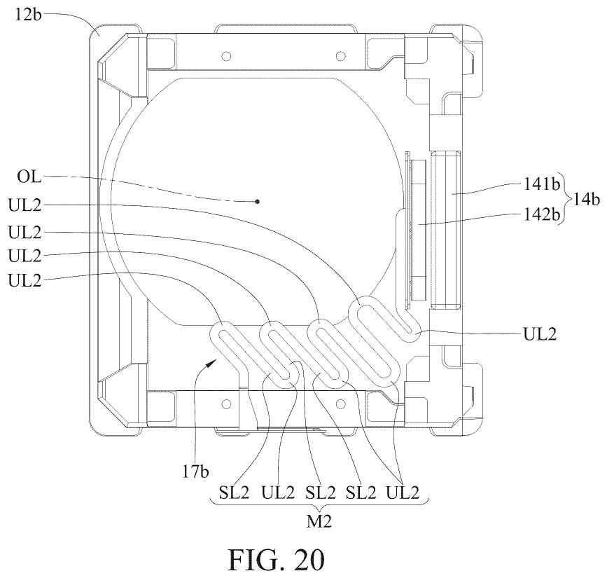

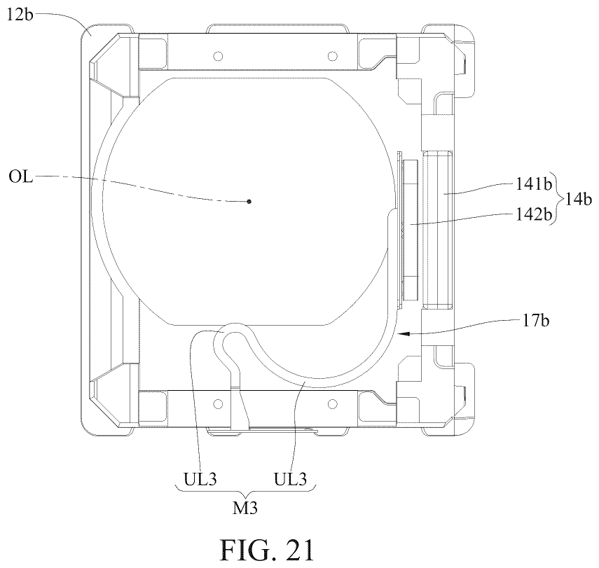

As shown in FIG. 14, and referring to FIG. 19, FIG. 19 is a top view of a flexible circuit board, an autofocus driving assembly and a base in the camera module in FIG. 10. In the 2nd embodiment, the flexible circuit board 17b includes a meandering circuit M1 with sections overlapping in a direction perpendicular to the optical axis OL. From the perspective of FIG. 19, the meandering circuit M1 has at least four turning sections UL1 on a plane perpendicular to the optical axis OL, and a plurality of straight sections SL1 extending in at least two perpendicular directions between the turning sections UL1. However, the present disclosure is not limited to the configuration of the meandering circuit M1 as shown in FIG. 19. For example, please refer to FIG. 20 and FIG. 21, which respectively show top views of a flexible circuit board, an autofocus driving assembly and a base in a camera module according to a first exemplary configuration and a second exemplary configuration of the present disclosure. The flexible circuit board 17b, the autofocus driving assembly 14b, and the base 12b shown in FIG. 20 and FIG. 21 are similar to the flexible circuit board 17b, the autofocus driving assembly 14b, and the base 12b shown in FIG. 10 to FIG. 19, respectively, and similar or identical reference numerals are used to denote similar or identical components. The functions and effects of these components are the same as previously described, so an explanation in this regard will not be provided again.

In the 1st exemplary configuration shown in FIG. 20, a meandering circuit M2 of the flexible circuit board 17b has sections overlapping in a direction perpendicular to the optical axis OL. From the perspective of FIG. 20, the meandering circuit M2 has at least eight bending turning sections UL2 on a plane perpendicular to the optical axis OL, and a plurality of straight sections SL2 extending in a direction inclined relative to the coil 142b between the turning sections UL2.

In the 2nd exemplary configuration shown in FIG. 21, a meandering circuit M3 of the flexible circuit board 17b has sections overlapping in a direction perpendicular to the optical axis OL. From the perspective of FIG. 21, the meandering circuit M3 has at least two bending turning sections UL3 on a plane perpendicular to the optical axis OL, with the curvature radius of one of the bending turning sections UL3 being larger than the curvature radius of the other of the bending turning sections UL3.

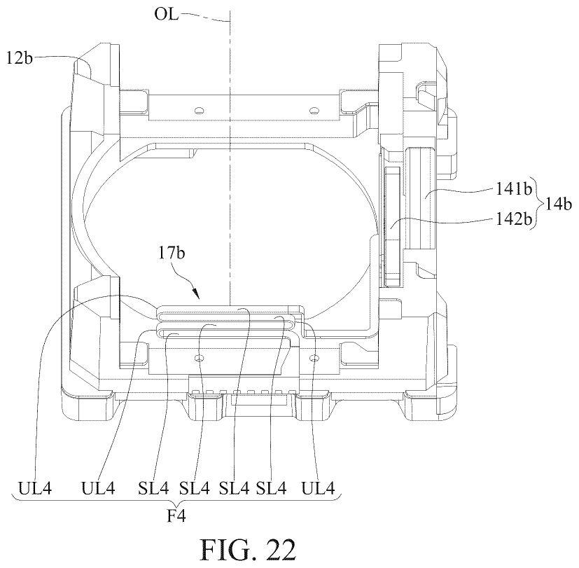

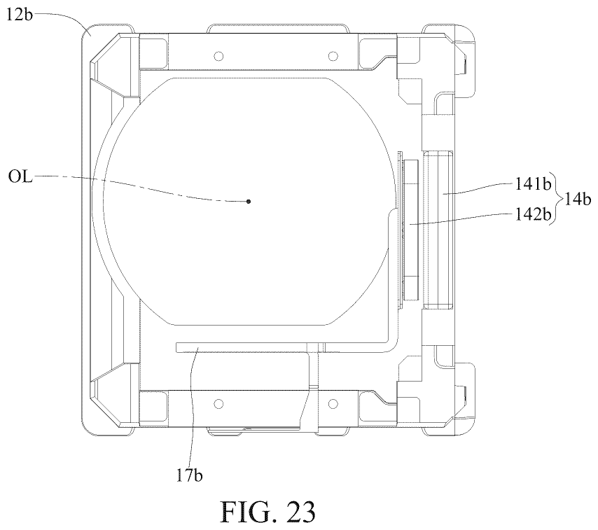

For another example, please refer to FIG. 22 and FIG. 23. FIG. 22 is a perspective view of a flexible circuit board, an autofocus driving assembly and a base in a camera module according to a third exemplary configuration of the present disclosure, and FIG. 23 is a top view of the flexible circuit board, the autofocus driving assembly and the base in the camera module of FIG. 22. The flexible circuit board 17b, the autofocus driving assembly 14b, and the base 12b shown in FIG. 22 and FIG. 23 are similar to the flexible circuit board 17b, the autofocus driving assembly 14b, and the base 12b shown in FIG. 10 to FIG. 19, respectively, and similar or identical reference numerals are used to denote similar or identical components. The functions and effects of these components are the same as previously described, so an explanation in this regard will not be provided again.

In the 3rd exemplary configuration shown in FIG. 22 and FIG. 23, the flexible circuit board 17b includes a folding circuit F4 with sections overlapping in a direction parallel to the optical axis OL (as shown in FIG. 22). The folding circuit F4 has at least three turning sections UL4 in a direction parallel to the optical axis OL, and a plurality of straight sections SL4 extending in the same direction between the turning sections UL4.

### 3rd Embodiment

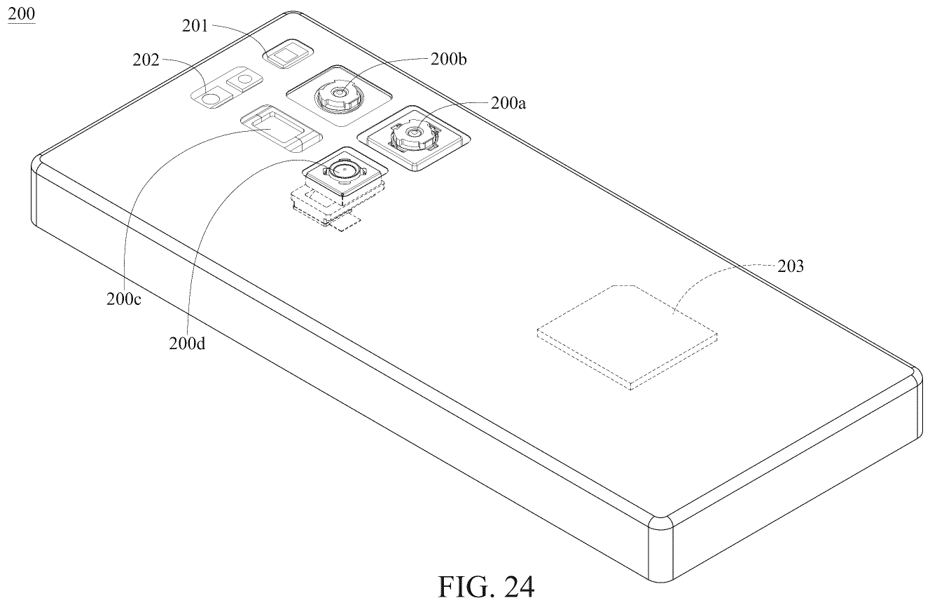

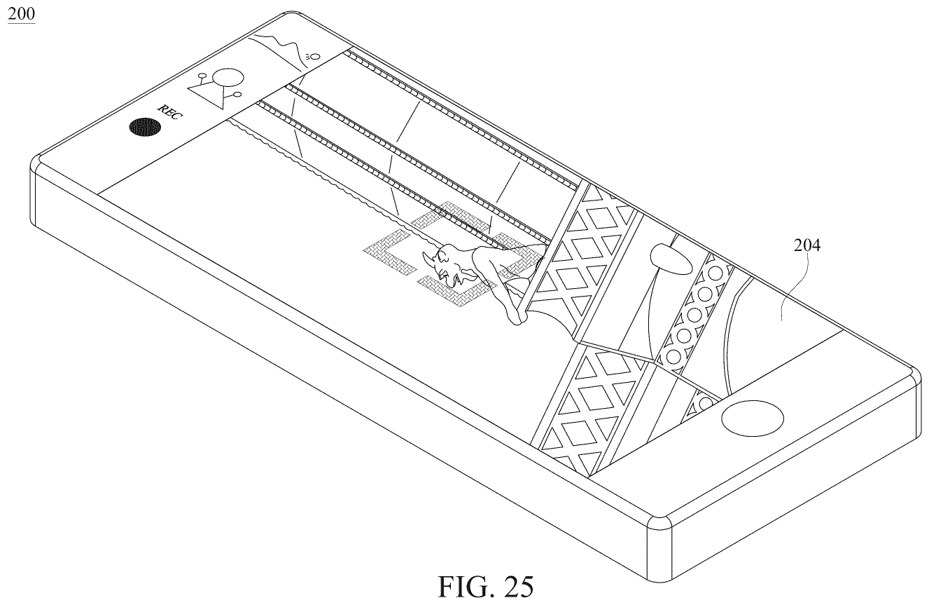

Please refer to FIG. 24 and FIG. 25. FIG. 24 is a perspective view of an electronic device according to the 3rd embodiment of the present disclosure, and FIG. 25 is another perspective view of the electronic device in FIG. 24.

In this embodiment, the electronic device 200 is a smartphone including a plurality of camera modules, a flash module 201, a focus assist module 202, an image signal processor 203, a display module (user interface) 204 and an image software processor (not shown).

These camera modules include an ultra-wide-angle camera module 200a, a high pixel camera module 200b, a telephoto camera module 200c and a telephoto camera module 200d. Moreover, the camera module 200d includes, for example, the imaging lens driving module 1 as disclosed in the 1st embodiment of the present disclosure, but the present disclosure is not limited thereto. At least one of the camera modules 200a, 200b, and 200c can include the imaging lens driving module of the present disclosure.

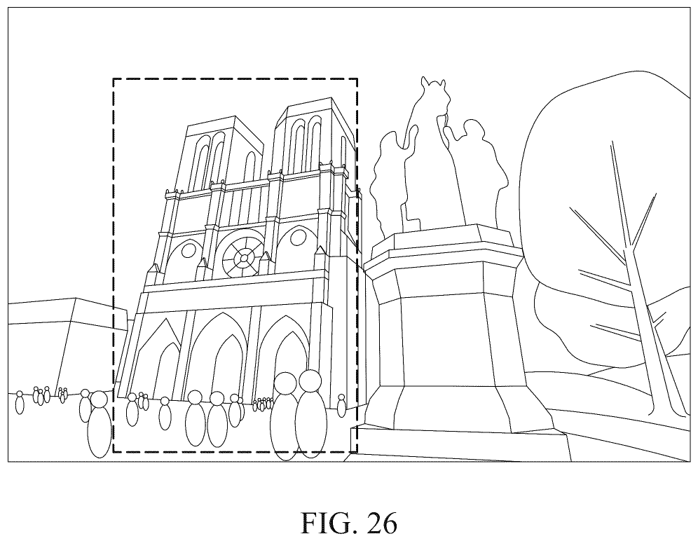

The image captured by the ultra-wide-angle camera module 200a enjoys a feature of multiple imaged objects. FIG. 26 is an image captured by the ultra-wide-angle camera module 200a.

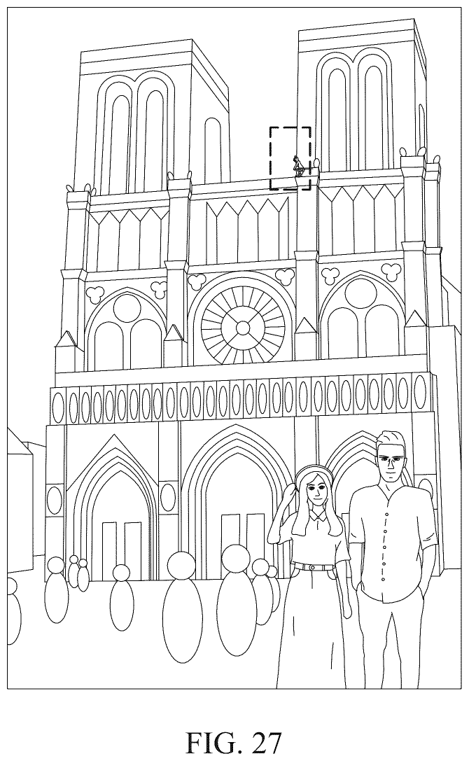

The image captured by the high pixel camera module 200b enjoys a feature of high resolution and less distortion, and the high pixel camera module 200b can capture part of the image in FIG. 26. FIG. 27 is an image captured by the high pixel camera module 200b.

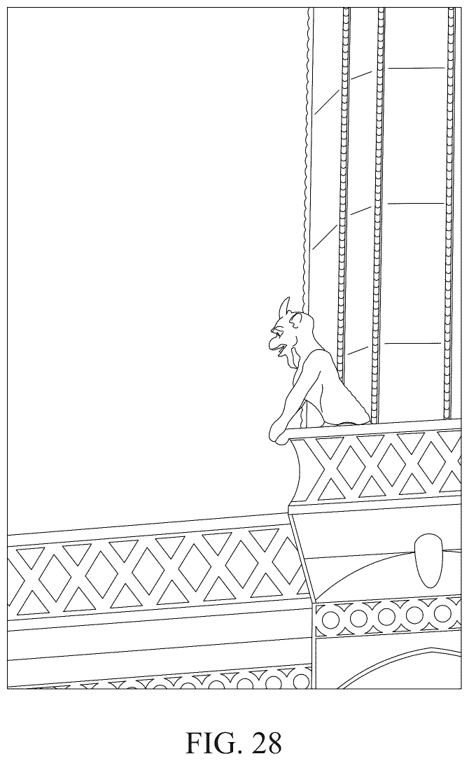

The image captured by the telephoto camera module 200c or the telephoto camera module 200d enjoys a feature of high optical magnification, and the telephoto camera module 200c or the telephoto camera module 200d can capture part of the image in FIG. 27. FIG. 28 is an image captured by the telephoto camera module 200c or the telephoto camera module 200d.

When a user captures images of an object, the light rays converge in the ultra-wide-angle camera module 200a, the high pixel camera module 200b, the telephoto camera module 200c or the telephoto camera module 200d to generate images, and the flash module 201 is activated for light supplement. The focus assist module 202 detects the object distance of the imaged object to achieve fast auto focusing. The image signal processor 203 is configured to optimize the captured image to improve image quality and provided zooming function. The light beam emitted from the focus assist module 202 can be either conventional infrared or laser. The display module 204 can include a touch screen, and the user is able to interact with the display module 204 to adjust the angle of view and switch between different camera modules, and the image software processor having multiple functions to capture images and complete image processing. Alternatively, the user may capture images via a physical button. The image processed by the image software processor can be displayed on the display module 204.

### 4th Embodiment

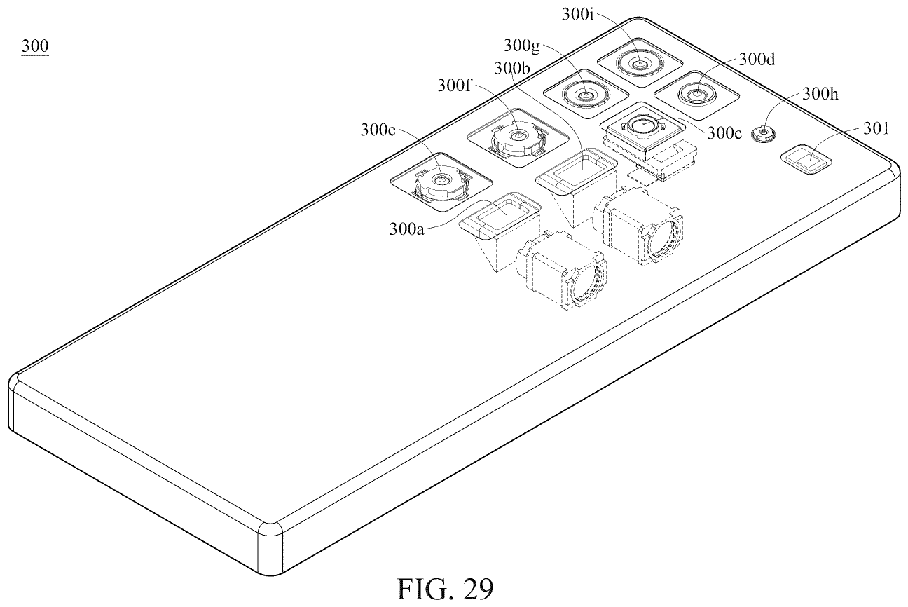

Please refer to FIG. 29, which is a perspective view of an electronic device according to the 4th embodiment of the present disclosure.

In this embodiment, the electronic device 300 is a smartphone including a camera module 300a, a camera module 300b, a camera module 300c, a camera module 300d, a camera module 300e, a camera module 300f, a camera module 300g, a camera module 300h, a camera module 300i, a flash module 301, an image signal processor, a display module and an image software processor (not shown). The camera module 300a, the camera module 300b, the camera module 300c, the camera module 300d, the camera module 300e, the camera module 300f, the camera module 300g, the camera module 300h and the camera module 300i are disposed on the same side of the electronic device 300, while the display module is disposed on the opposite side of the electronic device 300. Moreover, the camera module 300c includes, for example, the imaging lens driving module 1 as disclosed in the 1st embodiment of the present disclosure, but the present disclosure is not limited thereto. At least one of the camera modules 300a, 300b, 300d, 300e, 300f, 300g, 300h, and 300i can include the imaging lens driving module of the present disclosure.

The camera module 300a is a telephoto camera module, the camera module 300b is a telephoto camera module, the camera module 300c is a telephoto camera module, the camera module 300d is a telephoto camera module, the camera module 300e is a wide-angle camera module, the camera module 300f is a wide-angle camera module, the camera module 300g is a ultra-wide-angle camera module, the camera module 300h is a ToF (time of flight) camera module, and the camera module 300i is an ultra-wide-angle camera module. In this embodiment, the camera module 300i, the camera module 300a, the camera module 300b, the camera module 300c, the camera module 300d, the camera module 300e, the camera module 300f and the camera module 300g have different fields of view, such that the electronic device 300 can have various magnification ratios so as to meet the requirement of optical zoom functionality. In addition, the camera module 300a and camera module 300b are telephoto camera modules having a light-folding element configuration. In addition, the camera module 300h can determine depth information of the imaged object. In this embodiment, the electronic device 300 includes multiple camera modules 300a, 300b, 300c, 300d, 300e, 300f, 300g, 300h, and 300i, but the present disclosure is not limited to the number and arrangement of camera modules. When a user captures images of an object, the light rays converge in the camera module 300a, the camera module 300b, the camera module 300c, the camera module 300d, the camera module 300e, the camera module 300f, the camera module 300g, the camera module 300h or the camera module 300i to generate an image(s), and the flash module 301 is activated for light supplement. Further, the subsequent processes are performed in a manner similar to the abovementioned embodiments, so the details in this regard will not be provided again.

### 5th Embodiment

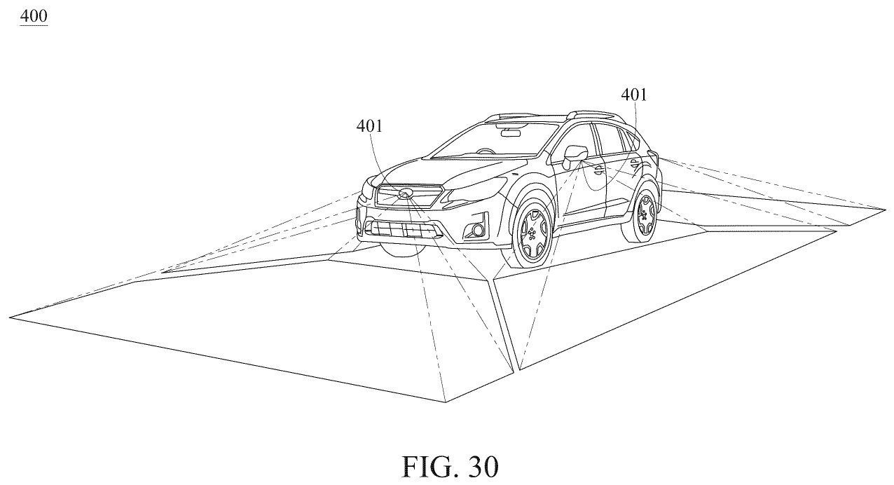

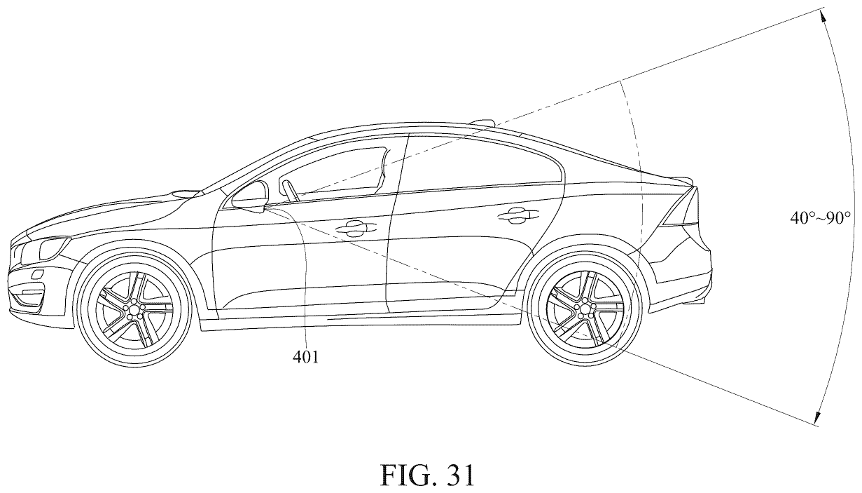

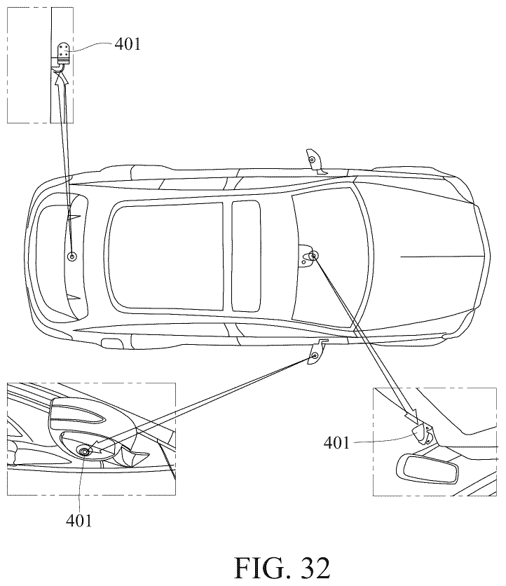

Please refer to FIG. 30 to FIG. 32. FIG. 30 is a perspective view of an electronic device according to the 5th embodiment of the present disclosure, FIG. 31 is a side view of the electronic device in FIG. 30, and FIG. 32 is a top view of the electronic device in FIG. 30.

In this embodiment, the electronic device 400 is an automobile. The electronic device 400 includes a plurality of automotive camera module 401, and the camera modules 401 each include the imaging lens driving module of the present disclosure. The camera modules 401 can serve as, for example, panoramic view car cameras, dashboard cameras and vehicle backup cameras.

As shown in FIG. 30, the camera modules 401 are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 31, the camera modules 401 are, for example, respectively disposed on the lower portion of the side mirrors. A maximum field of view of the camera modules 401 can be 40 degrees to 90 degrees for capturing images in regions on left and right lanes.

As shown in FIG. 32, the camera modules 401 can also be, for example, respectively disposed on the lower portion of the side mirrors and inside the front and rear windshields for providing external information to the driver, and also providing more viewing angles so as to reduce blind spots, thereby improving driving safety.

The smartphones, panoramic view car cameras, dashboard cameras and vehicle backup cameras in the embodiments are only exemplary for showing the imaging lens driving module of the present disclosure installed in an electronic device, and the present disclosure is not limited thereto. The imaging lens driving module can be optionally applied to optical systems with a movable focus. Furthermore, the imaging lens driving module features good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens driving module comprising:
a lens unit having an optical axis, the lens unit comprising a first track and a third track extending in a direction parallel to the optical axis, the first track comprising a second surface, and the third track comprising a third surface;
a base, wherein the lens unit is disposed relative to the base, the base comprises a second track and a fourth track extending in a direction parallel to the optical axis, the second track comprises a fifth surface and a sixth surface, the sixth surface and the fifth surface are connected and form an angle therebetween, the fourth track comprises a seventh surface and an eighth surface, and the eighth surface and the seventh surface are connected and form an angle therebetween;
a cover coupled to the base and forming an internal space with the base, wherein the internal space is configured to accommodate the lens unit, the first track and the second track are correspondingly arranged to accommodate at least one first ball, the third track and the fourth track are correspondingly arranged to accommodate at least one second ball, the at least one first ball and the at least one second ball are configured to provide the lens unit with a degree of freedom for movement in a direction parallel to the optical axis, and a total number of the at least one first ball and the at least one second ball is at least three;
an autofocus driving assembly configured to drive the lens unit to move in a direction parallel to the optical axis relative to the base, wherein the autofocus driving assembly comprises at least one magnet and at least one coil, the at least one coil is correspondingly disposed facing the at least one magnet, and one of the at least one magnet and the at least one coil is disposed on the lens unit; and
at least one flexible component disposed between the lens unit and the base and/or between the lens unit and the cover, wherein the at least one flexible component is deformable to reduce an impact caused by the lens unit bumping into adjacent components when the lens unit moves in a direction parallel to the optical axis;
wherein a movement path of a center of the at least one first ball along a direction parallel to the first track is defined as a first ball axis, a movement path of a center of the at least one second ball along a direction parallel to the third track is defined as a second ball axis, and a first connection line is defined as a line connected between the first ball axis and the second ball axis in a direction perpendicular to the optical axis;
wherein the sixth surface is located closer to a center point of the first connection line than the fifth surface, and the seventh surface is located closer to the center point of the first connection line than the eighth surface;
wherein the second surface, the fifth surface and the sixth surface each have only one contact point with the at least one first ball, and the third surface, the seventh surface and the eighth surface each have only one contact point with the at least one second ball;
wherein an angle between the sixth surface and the seventh surface is θ₆₇, an angle between the fifth surface and the eighth surface is θ₅₈, and the following condition is satisfied:
$$\vert {θ}_{67} - π \vert \leq \vert {θ}_{58} - π \vert ;$$
and
wherein the sixth surface and the seventh surface are parallel to each other.

2. The imaging lens driving module of claim 1, wherein the at least one flexible component is coupled to the base, and the at least one flexible component faces the lens unit.

3. The imaging lens driving module of claim 1, wherein the at least one flexible component is coupled to the lens unit, and the at least one flexible component faces the cover.

4. The imaging lens driving module of claim 1, wherein the at least one flexible component comprises at least two flexible components, and the at least two flexible components are respectively disposed between the lens unit and the base and between the lens unit and the cover.

5. The imaging lens driving module of claim 1, wherein a total number of the at least one flexible component is eight.

6. The imaging lens driving module of claim 1, wherein the at least one magnet is disposed on the lens unit, the at least one coil is disposed on the base, and the at least one coil is disposed corresponding to the at least one magnet.

7. The imaging lens driving module of claim 1, wherein the at least one coil is disposed on the lens unit, the at least one magnet is disposed on the base, and the at least one magnet is disposed corresponding to the at least one coil.

8. The imaging lens driving module of claim 7, further comprising:
a flexible circuit board coupled to the lens unit.

9. The imaging lens driving module of claim 8, wherein the at least one coil is disposed on the flexible circuit board, and the flexible circuit board comprises a meandering circuit with sections overlapping in a direction perpendicular to the optical axis.

10. The imaging lens driving module of claim 8, wherein the at least one coil is disposed on the flexible circuit board, and the flexible circuit board comprises a folding circuit with sections overlapping in a direction parallel to the optical axis.

11. The imaging lens driving module of claim 1, wherein the at least one first ball comprises at least two first balls, and the at least one second ball comprises at least two second balls.

12. The imaging lens driving module of claim 1, wherein a second connection line is defined as a line orthogonal to and intersecting both the optical axis and the first connection line and connected between the optical axis and the first connection line, an intersection point of the first connection line and the second connection line is an eccentric point, a distance between the center point of the first connection line and the second ball axis is d1, a distance between the eccentric point and the second ball axis is d2, and the following condition is satisfied:
$$1.1 \leq d 1 / d 2 < 4.9 .$$

13. The imaging lens driving module of claim 1, wherein a third connection line is defined as a line connected between a center of the at least one flexible component and the center point of the first connection line, a fourth connection line is defined as a line orthogonal to and intersecting the optical axis and connected between the optical axis and the center point, an angle between the third connection line and the first connection line is θa, an angle between the third connection line and the fourth connection line is θb, and the following condition is satisfied:
$$θ a + θ b \neq 90 degrees .$$

14. The imaging lens driving module of claim 1, wherein an angle between the fifth surface and the sixth surface is θ₅₆, an angle between the seventh surface and the eighth surface is θ₇₈, and the following conditions are satisfied:
$$π / 2 \leq {θ}_{56} < π ; \\ and \\ π / 2 \leq {θ}_{78} < π .$$

15. The imaging lens driving module of claim 14, wherein the angle between the fifth surface and the sixth surface is θ₅₆, the angle between the seventh surface and the eighth surface is θ₇₈, and the following conditions are satisfied:
$$98 degrees \leq {θ}_{56} < π ; \\ and \\ 98 degrees \leq {θ}_{78} < π .$$

16. The imaging lens driving module of claim 1, wherein the first track further comprises a first surface, the first surface and the second surface are connected and form an angle therebetween, the third track further comprises a fourth surface, and the fourth surface and the third surface are connected and form an angle therebetween;
wherein a gap is provided between the first surface and the at least one first ball and/or a gap is provided between the fourth surface and the at least one second ball; and
wherein the first surface and the sixth surface are parallel to each other, and the fourth surface and the seventh surface are parallel to each other.

17. A camera module comprising:
the imaging lens driving module of claim 1; and
an image sensor disposed on an image surface of the imaging lens driving module.

18. An electronic device comprising:
the camera module of claim 17.

19. An imaging lens driving module comprising:
a lens unit having an optical axis, the lens unit comprising a first track and a third track extending in a direction parallel to the optical axis, the first track comprising a second surface, and the third track comprising a third surface;
a base, wherein the lens unit is disposed relative to the base, the base comprises a second track and a fourth track extending in a direction parallel to the optical axis, the second track comprises a fifth surface and a sixth surface, the sixth surface and the fifth surface are connected and form an angle therebetween, the fourth track comprises a seventh surface and an eighth surface, and the eighth surface and the seventh surface are connected and form an angle therebetween;
a cover coupled to the base and forming an internal space with the base, wherein the internal space is configured to accommodate the lens unit, the first track and the second track are correspondingly arranged to accommodate at least one first ball, the third track and the fourth track are correspondingly arranged to accommodate at least one second ball, the at least one first ball and the at least one second ball are configured to provide the lens unit with a degree of freedom for movement in a direction parallel to the optical axis, and a total number of the at least one first ball and the at least one second ball is at least three;
an autofocus driving assembly configured to drive the lens unit to move in a direction parallel to the optical axis relative to the base, wherein the autofocus driving assembly comprises at least one magnet and at least one coil, the at least one coil is correspondingly disposed facing the at least one magnet, and one of the at least one magnet and the at least one coil is disposed on the lens unit; and
at least one flexible component disposed between the lens unit and the base and/or between the lens unit and the cover, wherein the at least one flexible component is deformable to reduce an impact caused by the lens unit bumping into adjacent components when the lens unit moves in a direction parallel to the optical axis;
wherein the second surface, the fifth surface and the sixth surface each have only one contact point with the at least one first ball, and the third surface, the seventh surface and the eighth surface each have only one contact point with the at least one second ball; and
wherein an angle between the sixth surface and the seventh surface is θ₆₇, an angle between the fifth surface and the eighth surface is θ₅₈, and the following condition is satisfied:
$$\vert {θ}_{67} - π \vert \leq \vert {θ}_{58} - π \vert .$$

20. The imaging lens driving module of claim 19, wherein the at least one flexible component is coupled to the base, and the at least one flexible component faces the lens unit.

21. The imaging lens driving module of claim 19, wherein the at least one flexible component is coupled to the lens unit, and the at least one flexible component faces the cover.

22. The imaging lens driving module of claim 19, wherein the at least one flexible component comprises at least two flexible components, and the at least two flexible components are respectively disposed between the lens unit and the base and between the lens unit and the cover.

23. The imaging lens driving module of claim 19, wherein a total number of the at least one flexible component is eight.

24. The imaging lens driving module of claim 19, wherein the at least one magnet is disposed on the lens unit, the at least one coil is disposed on the base, and the at least one coil is disposed corresponding to the at least one magnet.

25. The imaging lens driving module of claim 19, wherein the at least one coil is disposed on the lens unit, the at least one magnet is disposed on the base, and the at least one magnet is disposed corresponding to the at least one coil.

26. The imaging lens driving module of claim 25, further comprising:
a flexible circuit board coupled to the lens unit.

27. The imaging lens driving module of claim 26, wherein the at least one coil is disposed on the flexible circuit board, and the flexible circuit board comprises a meandering circuit with sections overlapping in a direction perpendicular to the optical axis.

28. The imaging lens driving module of claim 26, wherein the at least one coil is disposed on the flexible circuit board, and the flexible circuit board comprises a folding circuit with sections overlapping in a direction parallel to the optical axis.

29. The imaging lens driving module of claim 19, wherein the at least one first ball comprises at least two first balls, and the at least one second ball comprises at least two second balls.

30. The imaging lens driving module of claim 19, wherein a movement path of a center of the at least one first ball along a direction parallel to the first track is defined as a first ball axis, and a movement path of a center of the at least one second ball along a direction parallel to the third track is defined as a second ball axis;
wherein a first connection line is defined as a line connected between the first ball axis and the second ball axis in a direction perpendicular to the optical axis, a second connection line is defined as a line orthogonal to and intersecting both the optical axis and the first connection line and connected between the optical axis and the first connection line, an intersection point of the first connection line and the second connection line is an eccentric point, a distance between a center point of the first connection line and the second ball axis is d1, a distance between the eccentric point and the second ball axis is d2, and the following condition is satisfied:
$$1.1 \leq d 1 / d 2 < 4.9 .$$

31. The imaging lens driving module of claim 19, wherein a movement path of a center of the at least one first ball along a direction parallel to the first track is defined as a first ball axis, and a movement path of a center of the at least one second ball along a direction parallel to the third track is defined as a second ball axis;
wherein a first connection line is defined as a line connected between the first ball axis and the second ball axis in a direction perpendicular to the optical axis, a third connection line is defined as a line connected between a center of the at least one flexible component and a center point of the first connection line, a fourth connection line is defined as a line orthogonal to and intersecting the optical axis and connected between the optical axis and the center point, an angle between the third connection line and the first connection line is θa, an angle between the third connection line and the fourth connection line is θb, and the following condition is satisfied:
$$θ a + θ b \neq 90 degrees .$$

32. The imaging lens driving module of claim 19, wherein an angle between the fifth surface and the sixth surface is θ₅₆, an angle between the seventh surface and the eighth surface is θ₇₈, and the following conditions are satisfied:
$$π / 2 \leq {θ}_{56} < π ; \\ and \\ π / 2 \leq {θ}_{78} < π .$$

33. The imaging lens driving module of claim 32, wherein the angle between the fifth surface and the sixth surface is θ₅₆, the angle between the seventh surface and the eighth surface is θ₇₈, and the following conditions are satisfied:
$$98 degrees \leq {θ}_{56} < π ; \\ and \\ 98 degrees \leq {θ}_{78} < π .$$

34. The imaging lens driving module of claim 19, wherein the first track further comprises a first surface, the first surface and the second surface are connected and form an angle therebetween, the third track further comprises a fourth surface, and the fourth surface and the third surface are connected and form an angle therebetween;
wherein the first surface and the sixth surface are parallel to each other, and the fourth surface and the seventh surface are parallel to each other.

35. A camera module comprising:
the imaging lens driving module of claim 19; and
an image sensor disposed on an image surface of the imaging lens driving module.

36. An electronic device comprising:
the camera module of claim 35.
